(19) United States
(12) Patent Application Publication
(10) Pub. No.: US 2008/0197637 A1
(43) Pub. Date: Aug. 21, 2008

(54) Process for utilization of hydrostatic energy and gravity and resulting equipment

(76) Inventor: Jacson Polese Dos Santos, Curitiba (BR)

Correspondence Address: Keith Kline, 161 Little Pond Lane, Palmyra, VA, 22963-5161, US

(21) Appl. No.: 11/709,110

(22) Filed: Feb. 20, 2007

(51) Int. Cl. F03B 13/00

(52) U.S. Cl. 290/54

(57) ABSTRACT

The present patent of invention refers to a process for utilization of hydrostatic energy and gravity and the resulting equipment for generation of mechanical or electrical energy, through the utilization of a liquid storage tank (1) in a static form, with the use of thrust for the raising of the propellers (2), endowed with a set of bodies (2-A) linked to each other by belts or chains (3) inside the tank (1) and with the use of the force of gravity for the falling of the propellers (2) outside the tank (1), forming a thrust-gravity-power generation rotary cycle, bringing a clean, ecological and economic new option in energy generation, with a good cost-benefit relation.

### FIELD OF THE INVENTION

The present patent of invention refers to a process for utilization of hydrostatic energy and gravity and resulting equipment for generation of mechanical or electrical energy, through the utilization of a liquid storage tank in a static form, with the use of thrust for the raising of the propellers, endowed with a set of bodies (elements) linked to each other by belts or chains inside the tank and with the use of the force of gravity for the falling of the propellers outside the tank, forming a thrust-gravity-power generation rotary cycle, bringing a clean, ecological and economic new option in energy generation, with a good cost-benefit relation.

### BACKGROUND OF THE INVENTION

As it is well known by the technical means linked to mechanical engineering and hydraulics, nowadays the most effective system used in the energy generation from water are the hydroelectric plants, which take advantage of the potential energy of the stored water, through the flowing of water at high speed (hydrodynamics) through rotors generating mechanical or electrical energy.

By searching on the Brazilian patent database we found some patent applications with some proposals for hydrostatic energy generation:

a) Patent Application PI0107163-7 denominated MOTOR DRIVEN BY THE WATER STATIC FORCE, which discloses a motor of energetic conversion that extracts mechanical energy from a reservoir of static water, through a pendulum-type force binary, considering the law of thrust and the law of available weight-power in a central shaft.

b) Patent Application PI0301228-0 denominated ELECTRICAL GENERATOR BY THRUST, constituted by a strangling duct, toothed track for elevation, drum conveyor, steel pipe, machined bars in the back of the support and elevation gutters, welded bars, lift gears, orifices opened for water flowing, retainers, primary gears, speed amplifier and generator, which generates electric power from the thrust in a static water reservoir;

c) Patent Application PI0401353-0 denominated ELECTRIC GENERATOR BY THRUST FORCE IN A PARTIALLY IMMERSED WATER WHEEL, constituted of windows for insert of the spherical air chambers, partially immersed water wheel, shafts for holding and moving the drawers, shield, generator, speed amplifiers, base plate and floats, which generates electric power from the thrust in a static water reservoir;

d) Patent Application PI0202801-8 denominated GRAVITY AND THRUST MOTOR, constituted of a bell subjected to the force of gravity when the water tank is drained and to thrust when the water tank is filled, which generates electrical power by combining gravitational force and Archimedean thrust, from the thrust in a static water reservoir;

e) Patent Application PI0401385-9 denominated ELECTRICAL GENERATOR BY THRUST IN POTENTIAL PRESSURE IN THE BOTTOM OF RESERVOIRS AND OCEANS, constituted of orifices for breathing, cylinders with funneled tips, transversal belts, closing handles, steel cables, support point, support bars, slip bars, slip gutters, lift gears, toothed tracks, generator, amplifier, pulleys, impermeable and flexible bags, air chambers and traction belt, with generates electrical energy from the thrust in static water reservoir and oceans; and

f) Patent Application PI0403329-9 denominated HYDROSTATIC PERPETUAL MOTOR, constituted by rotary mechanism submerged in a water tank through air reservoirs that undergoes thrust and unload the air through bellows and by the force of gravity reload the bellows restarting the circuit, which generates driving force from the thrust and force of the gravity in static water reservoir.

Searching for patents in international patents databases, we found some patents with proposals of energy generation by hydrostatics energy and by the force of the gravity, such as the patents U.S. Pat. No. 5,201,260, CN1107549, FR2682432, FR2640325, AU4553679, CN1161411, FR2619601 and CN1525062.

The processes that use the hydrostatics energy and/or gravity presented in the state-of-art have inventive concepts that completely differ from the proposal of the present patent, present very limited results in terms of generated energy and present a poor cost/benefit ratio.

### SUMMARY OF THE INVENTION

“PROCESS FOR UTILIZATION OF HYDROSTATIC ENERGY AND GRAVITY AND RESULTING EQUIPMENT”, object of the present patent was developed to overcome the disadvantages, the inconvenient and the limitations of the current processes and equipment, because it uses liquid, preferably water, in a static form, with minimal loss of liquid and high energetic yielding, through the utilization of a liquid storage tank, with the use of thrust for the raising of the propellers, endowed with a set of bodies (elements) linked to each other by belts or chains inside the tank and with the use of the force of gravity for the falling of the propellers outside the tank, forming a thrust-gravity-power generation rotary cycle, bringing a clean, ecological and economic new option in mechanical or electrical energy generation.

Additionally, the process and equipment from the present patent present the following advantages:

very low consumption of replacement liquid;

use a small quantity of static liquid for its operation;

flexibility in propellers size and in the energy production capacity;

it does not need the nature (rainfalls) for its operation;

it does not invade productive agricultural areas;

lower investment in comparison with a conventional hydroelectric power station;

generation of electrical energy close to the consumer site, decreasing the elevated investments in electric power transmission;

high energetic efficiency; and

easiness of equipment transport, as the installation site can be easily changed.

### BRIEF DESCRIPTION OF THE DRAWINGS

For a better understanding the present patent, the following drawings are attached:

FIG. 1, which shows a schematic frontal view of the equipment of the present patent;

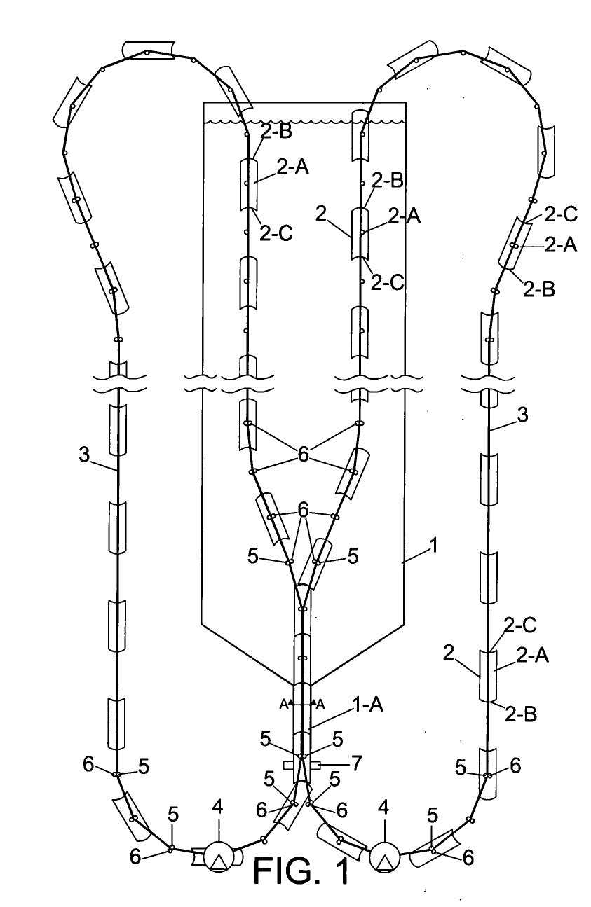

FIG. 2, which shows a schematic side view of the equipment of the present patent;

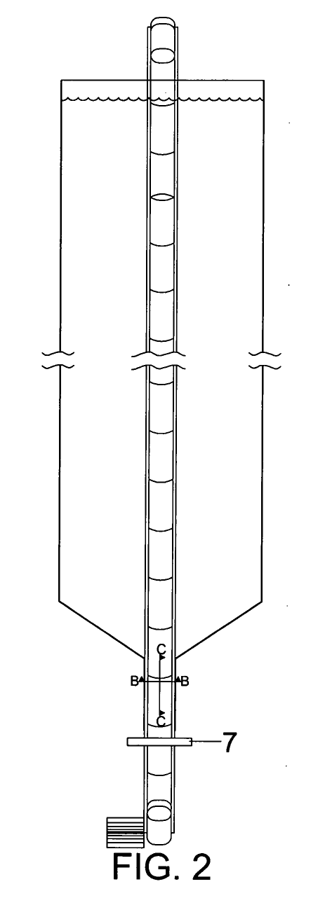

FIG. 3, which shows a schematic top view of the equipment of the present patent;

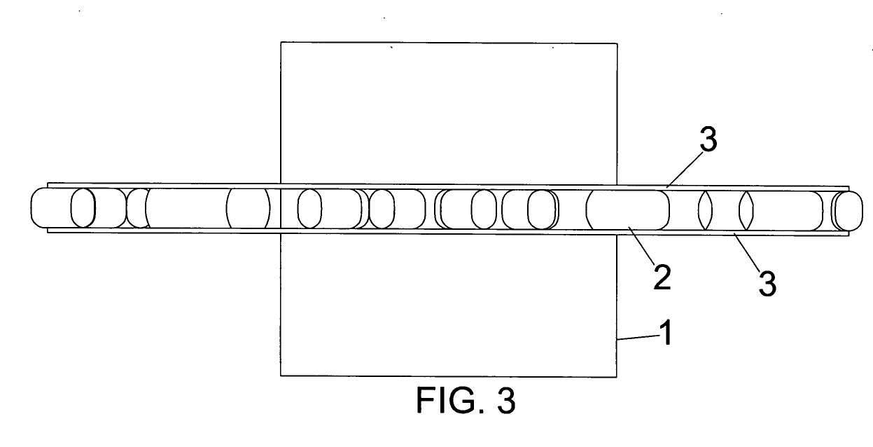

FIG. 4, which shows a schematic transversal cut AA of the bottom mouth of the equipment of the present patent;

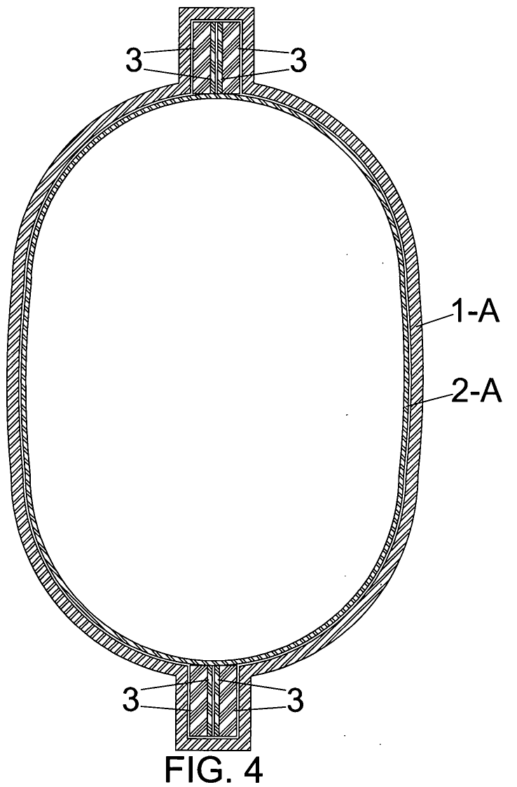

FIG. 5, which shows a schematic transversal cut BB of the bottom mouth of the equipment of the present patent;

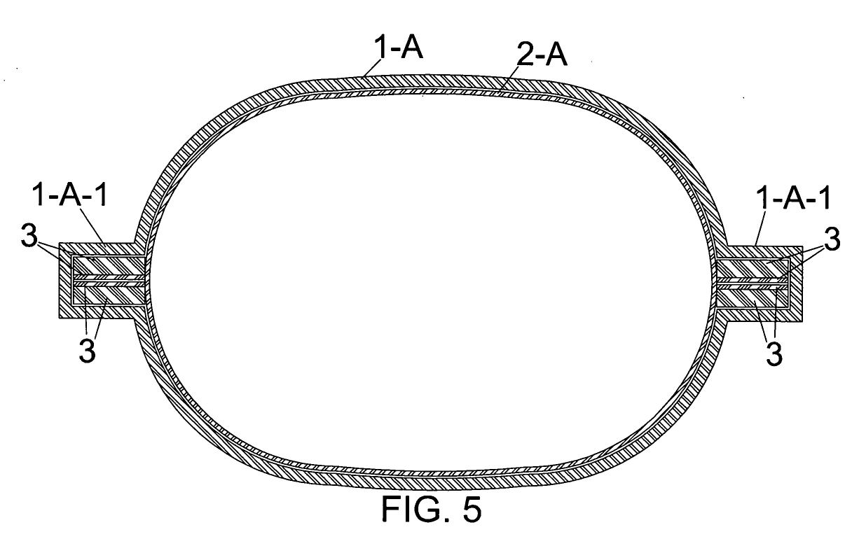

FIG. 6, which shows a schematic longitudinal cut CC of the bottom mouth of the equipment of the present patent; and

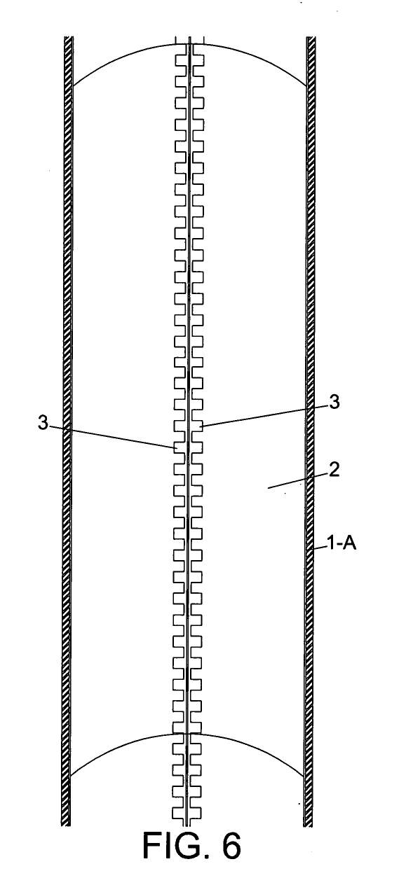

FIG. 7, which shows a block diagram of the process of the present patent;

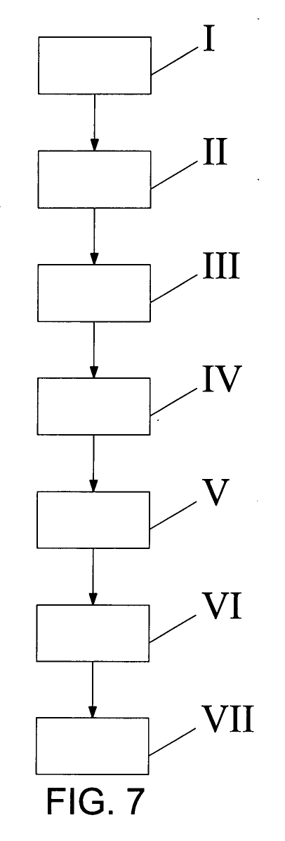

### DETAILED DESCRITION OF THE PREFERRED EMBODIMENTS

The process of the present patent is accomplished in the following sequence:

I) The tank (1) and its accessory are assembled, the propellers (2) are connected to the generators (4), they are positioned inside the tank (1) without liquid and the propellers (2) are locked to avoid the movement;

II) The filling of the tank (1) with liquid is started and the propellers (2) are unlocked;

III) The propellers (2) are subjected to thrust force inside the tank (1) with liquid and are pulled upwards at the same time in which the self weight of the propellers (2), positioned outside the tank (1), are subjected to the force of gravity, pulling them downwards, provoking a circulation of the propellers (2), providing a difference of potential energy and forming a rotary cycle;

IV) The propellers (2), when moving, create a resulting vector of the thrust, self weight and loss forces that combine with the set velocity will generate energy which will be transferred to the generators (4), remaining a part of the energy for continuity of the rotary cycle;

V) After passing through the generators (4), which converts the energy of the rotatory cycle in mechanical or electric energy, the propellers (2) re-enter in the tank (1) together encased to each other in one single column in order to minimize liquid leaks and to avoid the acting of the force of the liquid column over the propellers (2);

VI) The cycle continues, with the propellers (2) subjected to the force of thrust inside the tank (1) and the force of gravity outside the tank (1) like cited in the items III, IV and V; and

VII) If desirable, the process is interrupted by locking the propellers (2), combined or not with the emptying of the liquid in the tank (1).

The mechanism for sealing the bottom mouth (1-A) of the tank is based in the same encasing of the teeth of a zipper, in other words the continuous feeding of propellers (2) encased by the ordering and perfect encasing of the bodies (2-A) with special male and female format forming a column, minimizing the lost of liquid, by positioning of the belts (3) leaned each other in the lateral (1-A-1).

The equipment for utilization of hydrostatic energy and gravity from the present patent is endowed of tank for liquid reservoir (1) with cylindrical or polygonal prismatic format with bottom mouth (1-A) in form of duct of circular or elliptic or polygonal section with laterals (1-A-1) in polygonal section, propellers (2) endowed of bodies (2-A) in cylindrical oblong format or not, or polygonal prismatic format with superior cover (2-B) male in a convex or pyramidal format and fitted the bottom cover (2-C) and with bottom cover (2-C) female in concave or pyramidal format and fitted in the superior cover (2-B), belts or chains (3) connected in the broadside of the bodies (2) in closed circuit and passing by the generators shafts (4) positioned in the bottom outer part of the tank (1) and it could has pulleys or gears (5) and guides (6) for traction, guide and position conditioning of the propellers (2) and bolts (7) to stop the movement.

The embodiment does not limit the amplitude of the process of the present patent, in other words, other embodiments can be adopted to run the process.

The operation of the equipment has the following sequence:

a) When the tank (i) starts to receive the liquid, the bolts (7) of the propellers (2) are unlocked, allowing the movement of the propellers (2) upwards by thrust and downwards by gravity;

b) The propellers (2) are moved in casing perfectly in the bottom mouth (1-A), avoiding the leaking of liquid from inside of tank (1). Above the outlet of the tank (1-A) mouth and disjoint separating in two lines of propellers (2); and

c) The propellers (2) the belts (3) act the shafts of the generators (4) transforming in mechanical or electrical energy.

Alternatively, the equipment could adopt propellers (2) grouped during their ascent trajectory inside the tank (1), the separation occurs outside the tank (1), before its fall. Additionally, a tank (1) closed on its superior bottom, with similar superior and inferior mouth, can be used.

1. “PROCESS FOR UTILIZATION OF HYDROSTATIC ENERGY AND GRAVITY”, characterized by, the following sequence:
I) the tank (1) and its accessory are assembled, the propellers (2) are connected to the generators (4), they are positioned inside the tank (1) without liquid and the propellers (2) are locked to avoid the movement;
II) the filling of the tank (1) with liquid is started and the propellers (2) are unlocked;
III) The propellers (2) are subjected to thrust force inside the tank (1) with liquid and are pulled upwards at the same time in which the self weight of the propellers (2), positioned outside the tank (1), are subjected to the force of gravity, pulling them downwards, provoking a circulation of the propellers (2), providing a difference of potential energy and forming a rotary cycle;
IV) The propellers (2), when moving, create a resulting vector of the thrust, self weight and loss forces that combine with the set velocity will generate energy which will be transferred to the generators (4), remaining a part of the energy for continuity of the rotary cycle;
V) After passing through the generators (4), which converts the energy of the rotatory cycle in mechanical or electric energy, the propellers (2) re-enter in the tank (1) together encased to each other in one single column in order to minimize liquid leaks and to avoid the acting of the force of the liquid column over the propellers (2);
VI) the cycle continues, with the propellers (2) subjected to the force of thrust inside the tank (1) and the force of gravity outside the tank (1) like cited in the items III, IV and V; and
VII) if desirable, the process is interrupted by locking the propellers (2), combined or not with the emptying of the liquid in the tank (1).

2. “PROCESS FOR UTILIZATION OF HYDROSTATIC ENERGY AND GRAVITY”, according to claim 1, characterized by, sealing of the propellers (2) in the bottom mouth (1-A) occurs by continuous feeding of propellers (2) encased by the ordering and perfect encasing of the bodies (2-A) with special male and female format forming a column by positioning of the belts (3) leaned each other in the lateral (1-A-1).

3. “EQUIPMENT”, for accomplishment of the process cited in the claim 1, characterized by, tank for liquid reservoir (1) with cylindrical or polygonal prismatic format with bottom mouth (1-A) in form of duct of circular or elliptic or polygonal section with laterals (1-A-1) in polygonal section, propellers (2) endowed of bodies (2-A) in cylindrical oblong format or not, or polygonal prismatic format with superior cover (2-B) male in a convex or pyramidal format and fitted the bottom cover (2-C) and with bottom cover (2-C) female in concave or pyramidal format and fitted in the superior cover (2-B), belts or chains (3) connected in the broadside of the bodies (2) in closed circuit and passing by the generators shafts (4) positioned in the bottom outer part of the tank (1) and it could has pulleys or gears (5) and guides (6) for traction, guide and position conditioning of the propellers (2) and bolts (7).
